(19) United States
(12) Patent Application Publication
(10) Pub. No.: US 2023/0257859 A1
(43) Pub. Date: Aug. 17, 2023

(54) SOFT MAGNETIC MEMBER AND INTERMEDIATE THEREFOR, METHODS RESPECTIVELY FOR PRODUCING SAID MEMBER AND SAID INTERMEDIATE, AND ALLOY FOR SOFT MAGNETIC MEMBER

(71) Applicant: DAIDO STEEL CO., LTD., Nagoya-shi (JP)

(72) Inventors: Takamasa SATO, Nagoya-shi, Aichi (JP); Yusuke KUSAFUKA, Nogoya-shi, Aichi (JP); Chihiro FURUSHO, Nagoya-shi, Aichi (JP); Yoshihiko KOYANAGI, Nagoya-shi, Aichi (JP)

(21) Appl. No.: 18/014,098

(22) PCT Filed: Mar. 19, 2021
(86) PCT No.: PCT/JP2021/011547

§ 371 Date: Dec. 30, 2022

(30) Foreign Application Priority Data
Jul. 8, 2020 (JP) 2020-117770

(51) Int. Cl. C22C 38/10; C22C 38/02; C22C 38/04; H01F 1/147; C21D 9/46; H01F 1/16; C21D 8/02

(52) U.S. Cl. CPC C22C 38/10; C22C 38/02; C22C 38/04; H01F 1/147; C21D 9/46; H01F 1/16; C21D 8/0226; C21D 8/0236; C21D 8/0205

(57) ABSTRACT

An alloy for an Fe—Co-based soft-magnetic member, includes an alloy composition including, in terms of mass %, from 5.00% to 25.00% of Co, from 0.10% to 2.00% of Si, and from 0.10% to 2.00% of Al, provided that a total content of Si and Al is from 1.00% to 3.00%, with the balance being Fe and unavoidable impurities.

### TECHNICAL FIELD

The present invention relates to an alloy for an Fe—Co-based soft-magnetic member including Si and Al, and to a soft-magnetic member, an intermediate therefor, and methods for producing these.

### BACKGROUND ART

An electromagnetic steel sheets including alloy of Fe and Si is widely used as motor core material because magnetic properties including a heightened magnetic permeability (μ), a reduced loss (Pcm), and an increased saturation magnetic flux density (Bs) are obtained therewith. Meanwhile, recent motors are required to have a higher output, a smaller size, etc., and this has resulted in the development of soft-magnetic alloy which is Co-containing Fe alloy capable of obtaining a higher saturation magnetic flux density. Known is, for example, an Fe-49Co-2V material, commonly called “Permendur”, which has an excellent balance between saturation magnetic flux density (Bs) and magnetic permeability (μ). Meanwhile, since Co is an element far more expensive than Si and other elements, soft-magnetic alloy having reduced Co content has also been proposed.

For example, Patent Document 1 discloses an Fe—Co-based soft-magnetic alloy including Si and Al, which is for forming magnetic components such as the cores of transformers. Patent Document 1 states that in the case where the Co content is reduced to less than 35%, Si and Al are incorporated in accordance with the Co content. Patent Document 1 states that although the alloy is subjected to cold rolling and annealing (heat treatment) multiple times to obtain a sheet or strip, an upper limit of the addition amount of Co is decided so that any regular-irregular transformation does not occur rapidly and abruptly during the annealing.

### CITATION LIST

### Patent Literature

Patent Document 1: JP-T-2018-529021 (The term “JP-T” as used herein means a published Japanese translation of a PCT patent application.)

### SUMMARY OF INVENTION

### Technical Problem

Since Co is an extremely expensive element as stated above, the electromagnetic steel sheet including Co in large amounts have a problem concerning cost. Such electromagnetic steel sheet further have a problem concerning producibility in that the steel sheet yield a brittle phase (regular phase) because of the Co contained in large amounts and this makes formation into given products impossible unless cold workability is ensured by properly controlling the conditions for working and annealing.

An object of the present invention, which has been achieved in view of such circumstances, is to provide an alloy for an Fe—Co-based soft-magnetic member, which attains excellent producibility without impairing cold workability and to which Si and Al have been added in order to satisfy magnetic properties required of soft-magnetic member and especially attain a reduced loss, by regulating the amount of Co to be added to Fe and adding other elements thereto, and to provide a soft-magnetic member, an intermediate therefor, and methods for producing these.

### Solution to Problem

The alloy for an Fe—Co-based soft-magnetic member according to the present invention, the alloy including an alloy composition including, in terms of mass %,

from 5.00% to 25.00% of Co,

from 0.10% to 2.00% of Si, and

from 0.10% to 2.00% of Al,

(provided that a total content of Si and Al is from 1.00% to 3.00%),

with the balance being Fe and unavoidable impurities.

According to the feature, this alloy satisfies magnetic properties required of soft-magnetic member and can have excellent cold workability to ensure high producibility.

The invention described above is characterized in that the alloy composition may comprise, in terms of mass %, 0.020% or less of C, 0.10% or less of Mn, 0.010% or less of P, 0.005% or less of S, 0.05% or less of Cu, 0.10% or less of Ni, 0.10% or less of Cr, 0.10% or less of Mo, 0.010% or less of Ti, 0.005% or less of O, and 0.005% or less of N.

According to the feature, not only production stability is ensured and the magnetic properties required of soft-magnetic member are satisfied but also the alloy has excellent cold workability, making it possible to ensure high producibility.

The alloy material for an Fe—Co-based soft-magnetic member according to the present invention is characterized by including the alloy composition and having an average crystal grain diameter regulated to 200 μm or less.

According to the feature, the alloy material not only satisfies the magnetic properties required of soft-magnetic member but also has excellent cold workability, making it possible to ensure high producibility.

The preform for an Fe—Co-based soft-magnetic member according to the present invention, capable of providing the soft-magnetic member by being subjected to a magnetic regulation treatment with heating, in which the preform includes the alloy composition described above, and includes a cold-worked structure obtained by cold working.

According to the feature, a recrystallized structure is obtained by performing a magnetic regulation treatment with heating and the magnetic properties required of soft-magnetic member can be easily obtained.

The Fe—Co-based soft-magnetic member according to the present invention, including the alloy composition described above,

in which the Fe—Co-based soft-magnetic member is obtained by performing a magnetic regulation treatment so as to have an average crystal grain diameter of 40 μm or larger and a core loss, as measured at 1.5 T and 1 kHz, of 150 W/kg or less.

According to the feature, this soft-magnetic member has excellent producibility and has high magnetic properties required of soft-magnetic member.

In the above-described invention, the Fe—Co-based soft-magnetic member may have the feature of including a recrystallized structure formed by eliminating a working strain.

According to the feature, this soft-magnetic member has excellent producibility and has high magnetic properties required of soft-magnetic member.

A method for producing a preform for an Fe—Co-based soft-magnetic member according to the present invention, the preform capable of providing the soft-magnetic member by being subjected to a magnetic regulation treatment with heating.

the method including:

preparing an alloy material which includes an alloy comprising an alloy composition including, in terms of mass %,

from 5.00% to 25.00% of Co,

from 0.10% to 2.00% of Si, and

from 0.10% to 2.00% of Al,

(provided that a total content of Si and Al is from 1.00% to 3.00%), with the balance being Fe and unavoidable impurities, and which has an average crystal grain diameter regulated to 200 μm or less; and

cold-working the alloy material to form a cold-worked structure.

According to the feature, a preform for easily obtaining magnetic properties required of a soft-magnetic member can be obtained with high producibility by performing a magnetic regulation treatment with heating.

In the above-mentioned invention, the alloy composition may further comprise, in terms of mass %, 0.020% or less of C, 0.10% or less of Mn, 0.010% or less of P, 0.005% or less of S, 0.05% or less of Cu, 0.10% or less of Ni, 0.10% or less of Cr, 0.10% or less of Mo, 0.010% or less of Ti, 0.005% or less of O, and 0.005% or less of N.

According to the feature, a preform for easily obtaining magnetic properties required of a soft-magnetic member can be obtained with high producibility.

The method for producing an Fe—Co-based soft-magnetic member according to the present invention,

the method including:

preparing an alloy material which includes an alloy including an alloy composition comprising, in terms of mass %,

from 5.00% to 25.00% of Co,

from 0.10% to 2.00% of Si, and

from 0.10% to 2.00% of Al,

(provided that a total content of Si and Al is from 1.00% to 3.00%), with the balance being Fe and unavoidable impurities, and which has an average crystal grain diameter regulated to 200 μm or less;

cold-working the alloy material; and

performing a magnetic regulation treatment with heating so as to include a recrystallized structure having an average crystal diameter of 40 μm or large and have a core loss, as measured at 1.5 T and 1 kHz, of 150 W/kg or less.

According to the feature, a soft-magnetic member satisfying the magnetic properties required thereof can be obtained with high producibility by a working strain introduced with cold-working and a recrystallized structure obtained by recrystallization.

In the above-described invention, the alloy composition may further include, in terms of mass %, 0.020% or less of C, 0.10% or less of Mn, 0.010% or less of P, 0.005% or less of S, 0.05% or less of Cu, 0.10% or less of Ni, 0.10% or less of Cr, 0.10% or less of Mo, 0.010% or less of Ti, 0.005% or less of O, and 0.005% or less of N.

### Advantageous Effects of Invention

The present invention can provide: an alloy for an Fe—Co-based soft-magnetic member, which attains excellent producibility without impairing cold workability and to which Si and Al have been added in order to satisfy magnetic properties required of soft-magnetic members and especially attain a reduced loss; a soft-magnetic member, an intermediate therefor, and methods for producing the member and the intermediate.

### BRIEF DESCRIPTION OF DRAWINGS

FIG. 1 is a flow diagram showing an example of methods for producing a soft-magnetic member according to the present invention.

FIG. 2 is a table showing the compositions of alloys used in Production Test.

FIG. 3 is a table showing properties of soft-magnetic members obtained in Production Test.

FIG. 4 includes photographs of cross-sectional structures of (a) after annealing, (b) after cold wording, and (c) after a magnetic regulation treatment in Example 6.

### DESCRIPTION OF EMBODIMENTS

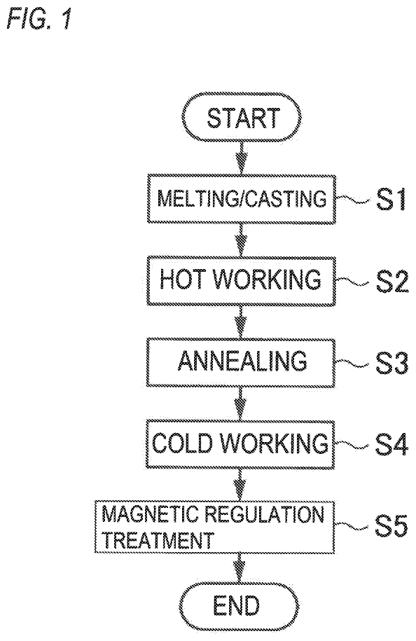

The soft-magnetic member as one example of the present invention, the alloy material for soft-magnetic member and the preform for a soft-magnetic member, which are intermediates for the soft-magnetic member according to the present invention, methods for producing the soft-magnetic member and preform, and the alloy for soft-magnetic member are described below using FIG. 1.

As FIG. 1 shows, in a method for producing a soft-magnetic member, an alloy for soft-magnetic member which includes a given composition is first melted and cast (S1).

Here, the alloy for soft-magnetic member is an Fe—Co-based alloy including an alloy composition including, in terms of mass %, from 5.00% to 25.00% of Co, from 0.10% to 2.00% of Si, and from 0.10% to 2.00% of Al. Provided that the alloy composition satisfies the condition in which the total content of Si and Al is from 1.00% to 3.00%.

The alloy composition obtained by thus regulating the amount of Co to be added to Fe and adding other elements makes it possible to obtain required soft-magnetic properties on a high level, without impairing the cold workability, in the finally obtained soft-magnetic member.

It is preferable that this Fe—Co-based alloy has undergone component regulation so as to have an α/α+γ transformation point of 950° C. or higher. Heightening the transformation point inhibits γ phase, which is an antiferromagnetic phase, from remaining even after the magnetic regulation treatment (magnetic annealing, heat treatment: S5) which will be described later, making it easy to obtain a soft-magnetic member having excellent magnetic properties.

The alloy composition may include, in terms of mass %, 0.020% or less of C, 0.10% or less of Mn, 0.010% or less of P, 0.005% or less of S, 0.05% or less of Cu, 0.10% or less of Ni, 0.10% or less of Cr, 0.10% or less of Mo, 0.010% or less of Ti, 0.005% or less of O, and 0.005% or less of N. These are impurities which are desirably diminished as much as possible. Although these impurity elements are permitted to be included so long as the impurity elements exert no influence on the magnetic and other properties of the soft-magnetic member, the production step in which the contents of these have been specified contributes to quality stabilization and enhancement of production stability.

The cast alloy for soft-magnetic member is then hot-worked (S2). Here, the cast alloy is shaped by blooming, hot forging and/or hot rolling into the shape, e.g., a billet, of the alloy material which will be described later. In the hot working, the heating temperature at least in the step of finally providing a strain is preferably lower than the α/α+γ transformation point. For example, the heating temperature is preferably 900° C. or lower. Thus, the growth of crystal grain during the hot working can be inhibited to enable an alloy material for soft-magnetic member that is to be obtained through the annealing (S3), which will be described later, to have an average crystal grain diameter of 200 μm or less. By thus maintaining relatively small crystal grain diameter in the hot working, cracking can be prevented in the cold working (S4), which will be described later. Incidentally, in the hot working, heating temperatures in steps other than the step of finally providing a strain are also preferably lower than the α/α+γ transformation point, from the standpoint of maintaining small crystal grain diameter. However, temperatures higher than that may be used in view of a burden to the forging equipment.

Subsequently, annealing for removing the working strain is conducted (S3) to regulate the average crystal grain diameter to 200 μm or less, thereby obtaining an alloy material for soft-magnetic member. Here, it is preferred to keep heating at a temperature in the range of, for example, from 700° C. to 900° C. in order to prevent excessive grain growth. Recrystallization can occur, depending on the working strain caused in the hot working (S2), and this also contributes to a reduction in crystal grain size and can inhibit grain growth. The alloy material obtained here is, for example, a plate material having a thickness of from 1.0 mm to 10.0 mm.

The alloy material prepared through the annealing is subjected to cold working (S4) to obtain a preform for a soft-magnetic member, having a working strain. Here, a working strain for causing recrystallization to form fine crystal grain in the magnetic regulation treatment (magnetic annealing, heat treatment: S5), which will be described later, is imparted beforehand. For the cold working, use can be made of a known working method such as cold rolling or cold drawing. In the case where the cold working cannot be carried out by one pass, the alloy material can be worked by a plurality of passes. In this case, intermediate annealing for facilitating the cold working may be performed therebetween. The intermediate annealing is conducted at a temperature in the range of from 600° C. to 900° C. so that any working strain that may be an obstacle to the cold working is removed and excess grain growth is prevented. Thus, a preform for a soft-magnetic member can be obtained, the preform having a cold-worked structure formed by the cold working. The preform for a soft-magnetic member is obtained, for example, as a sheet-shaped object having a thickness of from 0.01 mm to 0.9 mm.

The obtained preform for a soft-magnetic member is heated to conduct a magnetic regulation treatment (magnetic annealing: S5). This magnetic regulation treatment is magnetic annealing for forming regulated coarse crystal grain to attain a reduction in core loss, and is preferably conducted at a high temperature close to the α/α+γ transformation point. For example, the preform is held at a temperature in the range of from 850° C. to 950° C. in a vacuum or in a non-oxidizing atmosphere, e.g., decomposed-ammonia gas. Thus, the alloy structure is caused to have regulated coarse grain, thereby obtaining a structure having an average crystal grain diameter of 40 μm or larger. Hence, a soft-magnetic member having a excellent core loss can be obtained.

In the manner described above, an alloy material for soft-magnetic member can be obtained by subjecting the alloy for soft-magnetic member to the hot working (S2) and then to the annealing (S3) thereby obtaining an alloy material for soft-magnetic member, thereafter a preform for a soft-magnetic member can be obtained by subjecting the alloy material to the cold working (S4), and a soft-magnetic member having a recrystallized structure due to elimination of the working strain can be obtained through the magnetic regulation treatment (S5). Soft-magnetic properties required of soft-magnetic member are obtained on a high level without impairing the cold workability, especially by regulating the content of Co, etc.

### [Production Test]

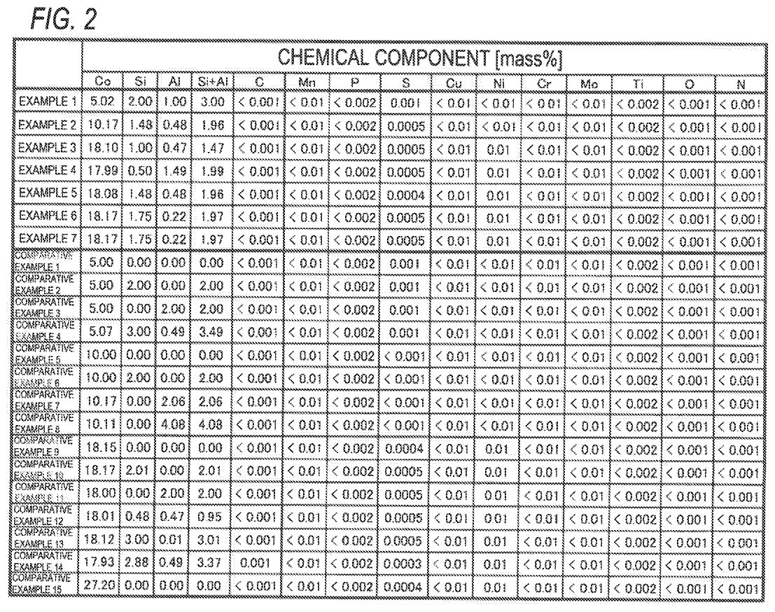

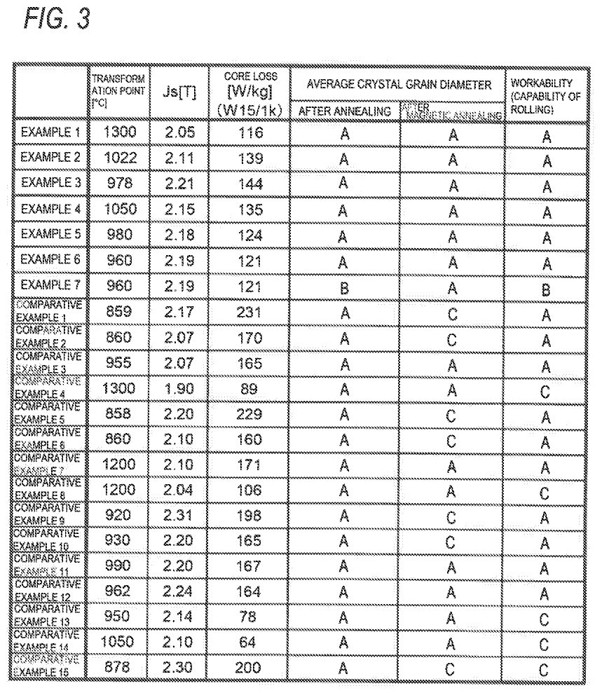

Next, the results of a test in which soft-magnetic members were actually produced are explained using FIG. 2 and FIG. 3.

First, alloys respectively having the compositions of Examples 1 to 7 and Comparative Examples 1 to 15 shown in FIG. 2 were each melted in a vacuum induction furnace and cast to obtain a 3.6-t steel ingot. The obtained steel ingot was bloomed, heated to 1,100° C. and hot-forged, and subsequently heated to 900° C. (or 970° C. in Example 7 only) and hot-rolled, thereby producing a plate-shaped coil having a thickness of 3.5 mm. Furthermore, scale was removed and annealing was conducted in which the coil was held in a nitrogen atmosphere at a temperature of 750° C. for 6 hours. The annealed coil was further cold-worked by performing cold rolling, intermediate annealing, and cold rolling in this order, thereby obtaining a 0.2-mm-thick sheet-shaped preform for a soft-magnetic member. Thereafter, a magnetic regulation treatment (magnetic annealing) was conducted in which the preform was held for 2 hours in an atmosphere of decomposed-ammonia gas at a temperature of 850° C. or 950° C., thereby obtaining a soft-magnetic member.

As shown in FIG. 3, each of test specimens which each had been cut out of the finally obtained test materials (soft-magnetic members) was examined for saturation magnetization (Js), core loss, and average crystal grain diameter. With respect to average crystal grain diameter, each of test specimens cut out of some of the test materials after the annealing (S3) (before the cold working) was also examined. Workability in the cold working (S4) was also evaluated. Incidentally, each of α/α+γ transformation point was determined using phase-diagram calculation software Thermo-Calc 2020a and alloy data base FE6 on the basis of alloy compositions determined by analysis (see Chemical components in FIG. 2) and recorded. A target value of the transformation point was set at 950° C. or higher.

With respect to saturation magnetization (Js), each of 0.2-mm-thick sheet-shaped test specimens was examined using a VSM (vibrating sample magnetometer) to record a value of magnetization at an intensity of magnetic field Hm of 2,000 kA/m. A target value of saturation magnetization (Js) was set at 2.05 T or higher.

With respect to core loss, five sheets of a 0.2-mm-thick sheet-shaped test specimen were stacked to produce an annular multilayer core having an outer diameter of 28 mm, an inner diameter of 20 mm, and a thickness of 1 mm, and a 100-turn primary wire coil and a 100-turn secondary wire coil were disposed. Using a known core loss measuring device, core loss was measured based on a signal occurring the loss Pcm of the multilayer core in the secondary wire coil when the primary wire coil was magnetized with an alternating-current magnetic field having a sine wave of 1.5 T and 1 kHz and recorded. A target value of the core loss under those conditions was set at 150 W/kg or less.

With respect to average crystal grain diameter, both the test material after the annealing (S3) and the finally obtained test material after the magnetic regulation treatment (S5) were examined as stated above. A test specimen cut out of each test material was examined for structure with an optical microscope at a 25 or 50 magnification with respect to five fields of view, and an average crystal grain diameter was determined by quadrature.

With respect to the test materials after the annealing (S3), the case where the average crystal grain diameter was 150 μm or less was rated as good and indicated by “A”, the case where the average crystal grain diameter was larger than 150 μm and 200 μm or less was rated as fair and indicated by “B”, and the case where the average crystal grain diameter was larger than 200 μm was rated as poor and indicated by “C”. With respect to the test materials after the magnetic regulation treatment (S5) (after magnetic annealing), the case where the average crystal grain diameter was 40 μm or larger was rated as good and indicated by “A” and the case where the average crystal grain diameter was less than 40 μm was rated as poor and indicated by “B”.

With respect to the evaluation of workability in cold working (S4), the workability was assessed in the following manner on the basis of the appearances of the test materials which had undergone the cold working. Each test material which had no cracks was rated as good and indicated by “A”, each test material which partly had cracks but was able to have the product shape was rated as fair and indicated by “B”, and each test material which entirely had cracks and was unable to have the product shape was rated as poor and indicated by “C”.

As shown in FIG. 3, in Examples 1 to 7, the α/α+γ transformation points were 950° C. or higher, the values of saturation magnetization (Js) were 2.05 T or larger, and the values of core loss were 150 W/kg or less; Examples 1 to 7 each satisfied the target values. With respect to average crystal grain diameter and workability, Examples 1 to 6 were “good” and Example 7 was “fair” in average crystal grain diameter after the annealing and in workability. Although Example 7 had a relatively large average crystal grain diameter after the annealing, this is thought to be due to the elevated hot-rolling temperature.

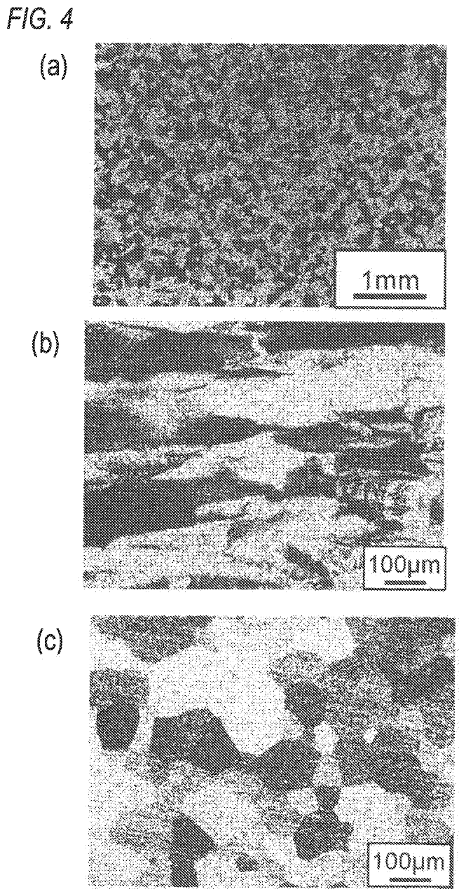

For example, as (a) of FIG. 4 shows, a structure having little orientation was observed in a photograph of a cross-sectional structure after the annealing (S3) in Example 6. This structure had an average crystal grain diameter of 100 μm, which was 150 μm or less. As (b) of FIG. 4 shows, in a photograph of a cross-sectional structure after the cold working (S4) in Example 6, crystal grains elongated in the right-hand/left-hand direction on the page were observed, indicating that the cold-worked alloy material had a cold-worked structure formed by the cold working. Furthermore, as (c) of FIG. 4 shows, in a photograph of a cross-sectional structure after the magnetic regulation treatment (S5) in Example 6, a structure including straightened crystal grain boundaries was observed, indicating that the treated alloy material had a recrystallized structure formed by eliminating the working strain. The alloy material after the magnetic regulation treatment (S5) in Example 6 had an average crystal grain diameter of 50 μm, which was 40 μm or larger.

As shown above, magnetic properties required of soft-magnetic member, such as a reduced core loss, were able to be obtained in Examples 1 to 7.

Meanwhile, Comparative Examples 1 to 4 contained about 5 mass % of Co like Example 1. Comparative Example 1 had a lowered transformation point and had a small average crystal grain diameter after the magnetic annealing (after magnetic regulation treatment (S5)). As a result, Comparative Example 1 had an increased core loss and was unable to obtain magnetic properties required of soft-magnetic member. This is thought to be because Comparative Example 1 contained neither Si nor Al. Comparative Example 2 also had a lowered transformation point and had a small average crystal grain diameter after the magnetic annealing. As a result, Comparative Example 2 had an increased core loss and was unable to obtain magnetic properties required of soft-magnetic member. This is thought to be because Comparative Example 2 contained no Al. Comparative Example 3, although having a transformation point of 950° C. or higher, had an increased core loss and was unable to obtain magnetic properties required of soft-magnetic member. This is thought to be because Comparative Example 3 contained no Si. Comparative Example 4, although obtaining magnetic properties required of soft-magnetic member, had poor workability. This is thought to be because Comparative Example 4, although containing both Si and Al, had too high an Si content.

Comparative Examples 5 to 8 each contained about 10 mass % of Co like Example 2. Comparative Examples 5 to 7 provided results similar to those of Comparative Examples 1 to 3, respectively, although differing in Co content. This is likewise thought to be attributable to whether Si and Al were contained. Comparative Example 8, although obtaining magnetic properties required of soft-magnetic member, had poor workability, like Comparative Example 4. This is thought to be because Comparative Example 8 had too high an Al content.

Comparative Examples 9 to 14 each contained about 18 mass % of Co like Examples 3 to 6. Comparative Examples 9 to 11 provided results similar to those of Comparative Examples 1 to 3, respectively, although differing in Co content. Comparative Example 12 had an increased core loss. This is thought to be because the total content of Si and Al was too low. Comparative Example 13, although having a low core loss, had poor workability. This is thought to be because Comparative Example 13 had too high a total content of Si and Al and because the Si content itself was too high while the Al content itself was too low. Comparative Example 14 had poor workability. This is thought to be because Comparative Example 14 had too high a total content of Si and Al and the Si content itself was also too high.

Comparative Example 15 had a Co content of 27.2 mass %, which was higher than in the Examples. Comparative Example 15 had a low transformation point and had a poor average crystal grain diameter after the magnetic annealing. As a result, Comparative Example 15 had a high core loss and poor workability. This is thought to be because Comparative Example 15 had too high a Co content and this undesirably had embrittled the material.

Meanwhile, ranges of the composition of the Fe—Co-based alloy including the Examples, which can provide soft-magnetic members, are decided in the following manner. First, essential additive elements are explained.

Co is an element essential for ensuring magnetic properties required of soft-magnetic member, and especially for obtaining a high saturation magnetic flux density Bs. Meanwhile, in case where Co is excessively included, this not only yields an Fe—Co-based regular phase to considerably embrittle the material but also results in a cost increase due to the extremely high-cost raw material. In view of this, the content of Co is in the range of from 5.00% to 25.00%, in terms of mass %.

Si not only heightens the electrical resistance of the material but also can ensure a low crystal magnetic-anisotropy constant and a low magnetostriction constant, which are regarded as important for soft-magnetic material, to greatly reduce the iron loss Pcm in use in a high-frequency range. Meanwhile, in the case where Si is excessively included, this results in a decrease in saturation magnetic flux density Bs and material embrittlement. In view of this, the content of Si is in the range of from 0.10 to 2.00%, preferably in the range of from 1.00% to 2.00%.

Al not only heightens the electrical resistance of the material but also can ensure a low crystal magnetic-anisotropy constant, which is regarded as important for soft-magnetic material, to greatly reduce the iron loss Pcm in use in a high-frequency range. Meanwhile, in the case where Al is excessively included, this results in a decrease in saturation magnetic flux density Bs and material embrittlement. In view of this, the content of Al is in the range of from 0.10% to 2.00%, preferably in the range of from 0.20% to 0.50%, in terms of mass %.

There is a lower limit on the total content of Si and Al so that magnetic properties including magnetic anisotropy are ensured. Meanwhile, in the case where the total content thereof is too high, this results in a decrease in saturation magnetic flux density Bs and material embrittlement. In view of this, the total content of Si and Al is in the range of from 1.00% to 3.00%, preferably in the range of from 1.40% to 3.00%, more preferably in the range of from 1.90% to 3.00%, in terms of mass %.

Next, elements which are impurities but are permitted to be included from the standpoint of ensuring production stability are explained.

C adversely affects the magnetic properties regardless of the state in which the C is present, and it is hence desirable to diminish C as much as possible. However, it is difficult to completely remove the C which has unavoidably come into the alloy in the production. Consequently, the acceptable content of C is 0.020% or less so that the content of C is within such a range that no influence is exerted on the magnetic properties required of soft-magnetic member.

Mn combines with S to thereby form a sulfide to impair the magnetic properties, and it is hence desirable to diminish Mn as much as possible. However, it is difficult to completely remove the Mn which has unavoidably come into the alloy in the production. Consequently, the acceptable content of Mn is 0.10% or less so that the content of Mn is within such a range that no influence is exerted on the magnetic properties required of soft-magnetic member.

P adversely affects the magnetic properties regardless of the state in which the P is present, and it is hence desirable to diminish P as much as possible. However, it is difficult to completely remove the P which has unavoidably come into the alloy in the production.

Consequently, the acceptable content of P is 0.010% or less so that the content of P is within such a range that no influence is exerted on the magnetic properties required of soft-magnetic member.

S combines with Mn to thereby form a falling matter to impair the magnetic properties, and it is hence desirable to diminish S as much as possible. However, it is difficult to completely remove the S which has unavoidably come into the alloy in the production. Consequently, the acceptable content of S is 0.005% or less so that the content of S is within such a range that no influence is exerted on the magnetic properties required of soft-magnetic member.

Cu adversely affects the magnetic properties regardless of the state in which the Cu is present, and it is hence desirable to diminish Cu as much as possible. However, it is difficult to completely remove the Cu which has unavoidably come into the alloy in the production. Consequently, the acceptable content of Cu is 0.05% or less so that the content of Cu is within such a range that no influence is exerted on the magnetic properties required of soft-magnetic member.

Ni, although being a magnetic element, impairs the magnetic properties of the soft-magnetic members of the Examples described above. It is hence desirable to diminish Ni as much as possible. However, it is difficult to remove the Ni which has unavoidably come into the alloy in the production. Consequently, the acceptable content of Ni is 0.10% or less so that the content of Ni is within such a range that no influence is exerted on the magnetic properties required of soft-magnetic member.

Cr adversely affects the magnetic properties regardless of the state in which the Cr is present, and it is hence desirable to diminish Cr as much as possible. However, it is difficult to completely remove the Cr which has unavoidably come into the alloy in the production. Consequently, the acceptable content of Cr is 0.10% or less so that the content of Cr is within such a range that no influence is exerted on the magnetic properties required of soft-magnetic member.

Mo adversely affects the magnetic properties regardless of the state in which the Mo is present, and it is hence desirable to diminish Mo as much as possible. However, it is difficult to completely remove the Mo which has unavoidably come into the alloy in the production. Consequently, the acceptable content of Mo is 0.10% or less so that the content of Mo is within such a range that no influence is exerted on the magnetic properties required of soft-magnetic member.

Ti combines with C and N to thereby form a carbide and a nitride to impair the magnetic properties, and it is hence desirable to diminish Ti as much as possible. However, it is difficult to completely remove the Ti which has unavoidably come into the alloy in the production. Consequently, the acceptable content of Ti is 0.010% or less so that the content of Ti is within such a range that no influence is exerted on the magnetic properties required of soft-magnetic member.

O, together with various elements, forms oxide-based inclusions which are stable even at high temperatures, and thus impairs the magnetic properties. It is hence desirable to diminish O as much as possible. However, it is difficult to completely remove the O which has unavoidably come into the alloy in the production. Consequently, the acceptable content of O is 0.005% or less so that the content of O is within such a range that no influence is exerted on the magnetic properties required of soft-magnetic member.

N combines with Al and Ti to thereby form nitrides to impair the magnetic properties, and it is hence desirable to diminish N as much as possible. However, it is difficult to completely remove the N which has unavoidably come into the alloy in the production. Consequently, the acceptable content of N is 0.005% or less so that the content of N is within such a range that no influence is exerted on the magnetic properties required of soft-magnetic member.

While representative Examples of the present invention have been described above, the present invention is not always limited thereto. A person skilled in the art will be able to variously replace or modify those Examples within the gist of the present invention or within the scope of the accompanying claims.

### INDUSTRIAL APPLICABILITY

The present invention can provide: an alloy for an Fe—Co-based soft-magnetic member, which attains excellent producibility without impairing cold workability to which Si and Al have been added in order to satisfy magnetic properties required of soft-magnetic member and especially attain a reduced loss; a soft-magnetic member, an intermediate therefor; and methods for producing these.

This application is based on a Japanese patent application filed on Jul. 8, 2020 (Application No. 2020-117770), the contents thereof being incorporated herein by reference.

1. An alloy for an Fe—Co-based soft-magnetic member, the alloy comprising an alloy composition consisting of, in terms of mass %,
from 5.00% to 25.00% of Co,
from 0.10% to 2.00% of Si,
from 0.10% to 2.00% of Al,
provided that a total content of Si and Al is from 1.00% to 3.00%,
0.020% or less of C,
0.10% or less of Mn,
0.010% or less of P,
0.005% or less of S,
0.05% or less of Cu,
0.10% or less of Ni,
0.10% or less of Cr,
0.10% or less of Mo,
0.010% or less of Ti,
0.005% or less of O, and
0.005% or less of N,
with the balance being Fe and unavoidable impurities.

2. (canceled)

3. An alloy material for an Fe—Co-based soft-magnetic member, comprising the alloy composition of the alloy described in claim 1 and having an average crystal grain diameter regulated to 200 μm or less.

4. A preform for an Fe—Co-based soft-magnetic member, capable of providing the soft-magnetic member by being subjected to a magnetic regulation treatment with heating,
wherein the preform comprises the alloy composition of the alloy described in claim 1, and comprises a cold-worked structure obtained by cold working.

5. An Fe—Co-based soft-magnetic member, comprising the alloy composition of the alloy described in claim 1,
wherein the Fe—Co-based soft-magnetic member is obtained by performing a magnetic regulation so as to have an average crystal grain diameter of 40 μm or larger and a core loss, as measured at 1.5 T and 1 kHz, of 150 W/kg or less.

6. The Fe—Co-based soft-magnetic member according to claim 5, comprising a recrystallized structure formed by eliminating a working strain.

7. A method for producing a preform for an Fe—Co-based soft-magnetic member, the preform capable of providing the soft-magnetic member by being subjected to a magnetic regulation treatment with heating,
the method comprising:
preparing an alloy material which comprises an alloy comprising an alloy composition consisting of, in terms of mass %,
from 5.00% to 25.00% of Co,
from 0.10% to 2.00% of Si,
from 0.10% to 2.00% of Al,
provided that a total content of Si and Al is from 1.00% to 3.00%,
0.20% or less of C,
0.10% or less of Mn,
0.010% or less of P,
0.005% or less of S,
0.05% or less of Cu,
0.10% or less of Ni,
0.10% or less of Cr,
0.10% or less of Mo,
0.010% or less of Ti,
0.005% or less of O, and
0.005% less of N,
with the balance being Fe and unavoidable impurities, and which has an average crystal grain diameter regulated to 200 μm or less; and
cold-working the alloy material to form a cold-worked structure.

8. (canceled)

9. A method for producing an Fe—Co-based soft-magnetic member,
the method comprising:
preparing an alloy material which comprises an alloy comprising an alloy composition consisting of, in terms of mass %,
from 5.00% to 25.00% of Co,
from 0.10% to 2.00% of Si, and
from 0.10% to 2.00% of Al,
provided that a total content of Si and Al is from 1.00% to 3.00%,
0.020% or less of C,
0.10% or less of Mn,
0.010% or less of P,
0.005% or less of S,
0.05% gr less of Cu,
0.10% or less of Ni,
0.10% or less of Cr,
0.10% or less of Mo,
0.010% or less of Ti,
0.005% or less of O, and
0.005% or less of N,
with the balance being Fe and unavoidable impurities, and which has an average crystal grain diameter regulated to 200 μm or less;
cold-working the alloy material; and
performing a magnetic regulation treatment by heating so as to comprise a recrystallized structure having an average crystal diameter of 40 μm or large and have a core loss, as measured at 1.5 T and 1 kHz, of 150 W/kg or less.

10. (canceled)
